(19) United States
(12) Patent Application Publication
(10) Pub. No.: US 2025/0230981 A1
(43) Pub. Date: Jul. 17, 2025

(54) DENTAL FURNACE

(71) Applicant: Ivoclar Vivadent AG, Schaan (LI)

(72) Inventors: Gregor BECK, Schaan (LI); Rudolf JUSSEL, Feldkirch-Gisingen (AT)

(21) Appl. No.: 19/015,055

(22) Filed: Jan. 9, 2025

(30) Foreign Application Priority Data
Jan. 12, 2024 (EP) 24151547

(51) Int. Cl. F27B 17/02; A61C 13/083; F27D 7/06; F27D 99/00

(52) U.S. Cl. CPC F27B 17/025; A61C 13/083; F27D 7/06; F27D 99/00; F27D 2007/066; F27D 2099/0086

(57) ABSTRACT

A dental furnace (100) having a base plate (103) for arranging a dental object (105) to be heated and an inlet opening (107) for supplying air into the firing chamber (109) and an outlet opening (111) for discharging air from the firing chamber (109), both of which are arranged in the base plate (103) or a furnace head (115).

### CROSS-REFERENCE TO RELATED APPLICATIONS

This application claims priority to European patent application No. 24151547.7 filed on Jan. 12, 2024, which disclosure is incorporated herein by reference in its entirety.

### TECHNICAL FIELD

The present invention relates to a dental furnace and a method of operating a dental furnace.

### BACKGROUND

Drying and heating a dental restoration in a dental furnace is a difficult process step. Layering ceramics, glazes or stains are often applied in paste form to the prepared dental restorations and dried and fired in the dental furnace.

If the dental restoration is heated too quickly before the paste has dried or if too much material is processed in the dental furnace at the same time, grey discoloration may occur during firing or the applied layer may crack. If, on the other hand, the drying process is too slow, time is wasted and the firing program takes correspondingly longer.

Previously, the dental restoration coated with paste was placed in the warm dental furnace and the program was started. The program comprises a defined closing time until the furnace head is completely closed, for example from four to six minutes. During this closing time, the dental restoration dries due to the residual heat of the dental furnace and the resulting natural convection. Alternatively, the drying of the dental restoration can also be controlled via an infrared camera. The infrared camera measures the temperature of the dental restoration and controls the head movement in such a way that a defined heating gradient is created. As soon as the dental restoration is dry, the dental furnace is closed.

U.S. Pat. No. 9,285,169 B2 is directed to a sintering device and is hereby incorporated by reference in its entirety.

### SUMMARY OF THE INVENTION

It is therefore the technical task of the present invention to provide a dental furnace which enables a dental restoration to be processed more efficiently.

This task is solved by subject-matter according to the independent claims. Advantageous embodiments are the subject-matter of the dependent claims, the description and the figures.

According to a first aspect, the technical task is solved by a dental furnace comprising a base plate for arranging a dental object to be heated; and an inlet opening for supplying air into the firing chamber and an outlet opening for discharging air from the firing chamber, both of which are arranged in the base plate or a furnace head. The inlet opening and the outlet opening can advantageously be arranged in the component that is immovable relative to the other component. The dental furnace has the technical advantage that convection can be generated around the dental object in order to dry the dental object more quickly and to continuously draw oxygen into the firing chamber to accelerate the debinding process. The gases and vapors produced during drying and debinding can be removed from the firing chamber. This can speed up the production of the dental object.

In a technically advantageous embodiment of the dental furnace, the inlet opening and/or the outlet opening are slit-shaped or circular. The inlet opening and the outlet opening on the firing chamber can be bores with a diameter of 4 mm. The path from these bores to the firing chamber through a thermal insulation runs through slits.

This achieves the technical advantage, for example, that an air flow with a large width can be generated.

In a further technically advantageous embodiment of the dental furnace, the slit-shaped inlet opening and/or the slit-shaped outlet opening has a length between 35 mm and 45 mm and a width between 0.5 mm and 1.5 mm. In particular, the slit can have a length of 40 mm and a width of 1 mm. This achieves the technical advantage, for example, that the dental object can be cooled particularly efficiently.

In a further technically advantageous embodiment of the dental furnace, the slit-shaped inlet opening and/or the slit-shaped outlet opening is arranged radially to the center of the base plate. This has the technical advantage, for example, that the air can be easily directed towards the dental object.

In a further technically advantageous embodiment of the dental furnace, the slit-shaped inlet opening and the slit-shaped outlet opening are opposite each other with respect to the center of the base plate. This achieves the technical advantage, for example, that the air flows past the dental objects.

In a further technically advantageous embodiment of the dental furnace, the inlet opening and/or the outlet opening are configured to guide an air flow around a central region of the base plate. This achieves the technical advantage, for example, that the air flow can be precooled by the base plate. The hot air from the firing chamber is precooled during suction by flowing through the colder thermal insulation and releasing energy there. The cooling protects the hoses, valves, filters and the pump.

In a further technically advantageous embodiment of the dental furnace, the dental furnace comprises a closed furnace head for lowering onto the base plate or a movable base plate. This achieves the technical advantage, for example, that a closed firing chamber is formed above the firing plate.

In a further technically advantageous embodiment of the dental furnace, the dental furnace comprises several inlet openings and/or several outlet openings in the firing chamber, for example in the base plate and/or the furnace head. This achieves the technical advantage, for example, that the cooling of the dental object is further improved.

In a further technically advantageous embodiment of the dental furnace, the dental furnace comprises a vacuum pump for generating an air flow through the inlet opening and/or the outlet opening. The vacuum pump can be connected to the dental furnace as an external device or integrated into the dental furnace. This achieves the technical advantage, for example, that the air flow can be generated efficiently.

In a further technically advantageous embodiment of the dental furnace, the dental furnace comprises a filter which is arranged upstream of an inlet valve, an outlet valve and/or a vacuum pump. In particular, the filter can be arranged between the firing chamber and the outlet valve or the vacuum pump.

This achieves the technical advantage, for example, that the respective components are protected from contamination or deposits.

According to a second aspect, the technical task is solved by a method of operating a dental furnace, comprising the steps of arranging a dental object to be heated on a base plate; and discharging air from the firing chamber via an outlet opening and supplying air into the firing chamber via an inlet opening, both of which are arranged in the base plate or a furnace head. The method achieves the same technical advantages as the dental furnace according to the first aspect.

In a technically advantageous embodiment of the method, the air is discharged via the outlet opening when the furnace head is open or closed. This achieves the technical advantage, for example, that the dental object can be dried and/or debinded quickly.

In a further technically advantageous embodiment of the method, the air is supplied via an inlet opening arranged in the base plate. This achieves the technical advantage, for example, that convection is generated around the dental object.

In a further technically advantageous embodiment of the method, the air is supplied when the furnace head is closed. This achieves the technical advantage, for example, that convection is improved even further.

In a further technically advantageous embodiment of the method, the air is discharged by means of a vacuum pump. This achieves the technical advantage, for example, that the air can be generated efficiently.

In a further technically advantageous embodiment of the method, the air is filtered upstream of an inlet valve, an outlet valve and/or a vacuum pump through a filter. In particular, the filter can be arranged between the firing chamber and the outlet valve. This achieves the technical advantage, for example, that the respective components are protected from contamination or deposits.

### BRIEF DESCRIPTION OF THE DRAWINGS

Exemplary embodiments of the invention are shown in the drawings and are described in more detail below, in which:

FIG. 1 shows a schematic view of a dental furnace with an open furnace head;

FIG. 2 shows a schematic view of a dental furnace with a closed furnace head;

FIG. 3 shows a top view of a base plate for arranging a dental object to be heated;

FIG. 4 shows a course of a firing program; and

FIG. 5 shows a block diagram of a method of operating a dental furnace.

### DETAILED DESCRIPTION

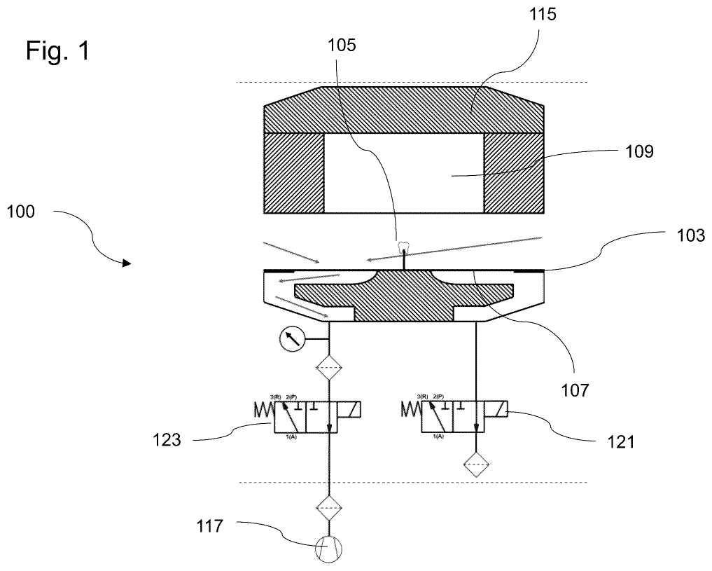

FIG. 1 shows a schematic view of a dental furnace 100 with an open furnace head 115. The dental furnace 100 is used for heating and tempering a dental object 105, such as a dental restoration. The dental furnace 100 comprises a furnace head 115, which can be lowered onto a base plate 103. A closed firing chamber 109 is formed by the lowered furnace head 115 and the base plate 103. The dental object 105 to be heated is located in the firing chamber 109.

The base plate 103 comprises an inlet opening 107 for supplying air and an outlet opening 111 for discharging air. With the aid of a fresh air function, forced convection of air can be generated around the dental object 105 when the furnace head 115 is open in order to dry the dental object 105 more quickly, for example in three instead of six minutes.

The forced convection is created by generating an air flow through the outlet opening 111 when the valves 123 are open. This air flow is generated by switching on a vacuum pump 117 and drawing in air through the outlet opening in the base plate 103. There is no active air flow through the opposite inlet opening 107. The dental object 105 can be cooled by this air flow even when the furnace head 115 is open.

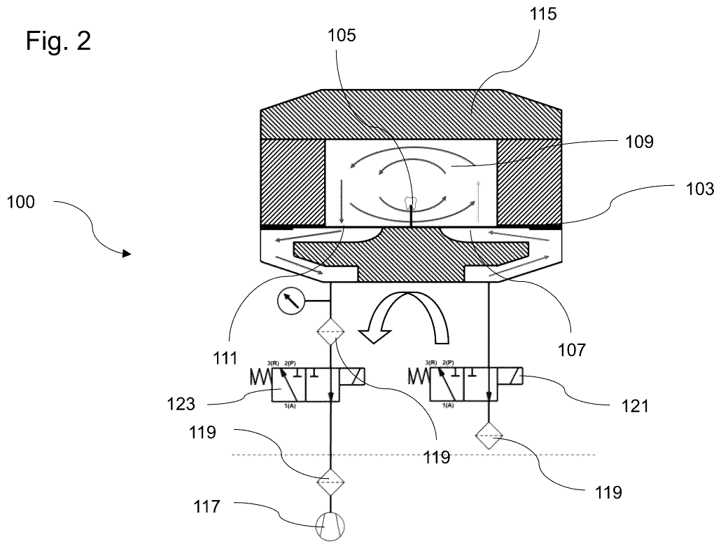

FIG. 2 shows a schematic view of a dental furnace 100 with a closed furnace head 115. The fresh air function can draw fresh air through the firing chamber 109 when the furnace head 115 is closed, for example with a flow rate of 10 l/min. When the furnace head 115 is closed, the air flows through the outlet opening 111 and is drawn out of the firing chamber 109. Fresh air enters the firing chamber via the inlet opening 107.

The gases and vapors generated during the drying of the dental object 105 are sucked off so that the odor development around the dental furnace 100 is reduced and the dental restoration is not undesirably discolored or damaged during firing. Depending on the furnace temperature (approx. <250° C.), the dental object 105 can be dried completely in the closed dental furnace 100, for example when the fresh air function is activated.

In addition to this effect, forced convection is generated around the dental object 105, as with an open furnace head 115. With natural convection, drying takes longer than with forced convection (fresh air function).

The sucked off gases and vapors are filtered before a valve 123 by a filter 119, a cold trap, a gas washing bottle, a granulate, an absorption filter, a carbon filter or similar device in order to protect the valve 123. The flow is only in one direction, so no check valve is required. Valves 121 and 123 are used to create and maintain a vacuum in the firing chamber. Valve 121 is initially closed while the vacuum pump draws the air out of the firing chamber 109. As soon as a sufficient vacuum is reached in the firing chamber 109, valve 123 is also closed so that the firing chamber 109 is sealed.

Unpleasant odors can arise when drying pastes on the dental object 105. When the dental object 105 is dried in the closed dental furnace 100, these odors can be efficiently removed via the vacuum pump 117.

No T- or Y-piece and no bypass are used here. The air, which is sucked off by the vacuum pump 117, flows completely through the firing chamber 109. The connections are not arranged opposite each other, but on the same side, i.e. both in the base plate 103 or both in the furnace head 115. The hot air from the firing chamber 109 flows outwards through slits or a labyrinth in the thermal insulation and is precooled here.

The air drawn in through the inlet opening 107 is also drawn in and preheated by the thermal insulation. In this case, the furnace head 115 can be closed more quickly, as the drying of the dental object 105 takes place faster. The program run time is thus shortened.

Depending on the furnace temperature (approx. <250° C.), the furnace head 115 can be closed immediately at the start of the program. This means that the unpleasant odors are sucked off via the vacuum pump while the restoration is drying. In addition, more material can be processed simultaneously by the dental furnace 100 without any loss of quality. The risk of grey discoloration and cracks in the dental object 105 is reduced.

The cooling gradient with the furnace head 115 closed at the end of the program can be accelerated by drawing fresh air through the firing chamber 109. This allows the dental object 105 to be cooled quickly after firing to just before the glass transition temperature. The glass transition is then run through slowly and the dental object 105 is then cooled down again quickly. This reduces the program run time.

The standby temperature of the dental furnace 100 can be reduced, for example from 400° C. to 200° C., as the drying of the dental restoration 105 is supported with fresh air. This has the advantage that the dental furnace 100 consumes less energy.

The measured pressure drop (approx. 0.1 bar) in the firing chamber 109 when the fresh air function is activated can also be used to indirectly measure the flow rate (approx. 10 l/min) through the firing chamber 109. The performance of the vacuum pump 117 can be assessed with the aid of the measured pressure drop in the firing chamber 109 when the fresh air function is activated.

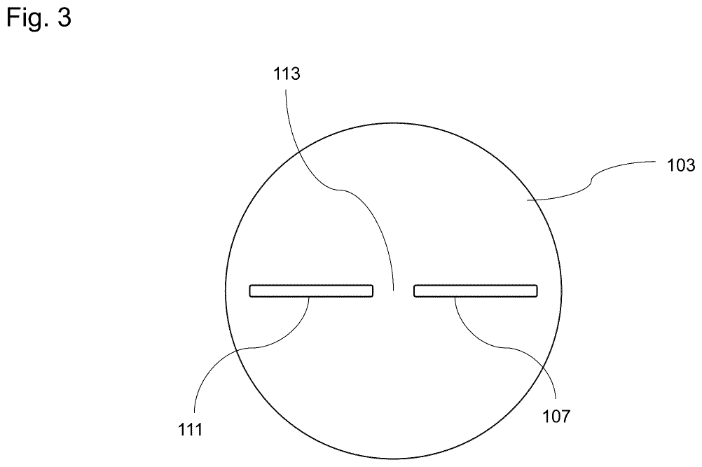

FIG. 3 shows a top view of the base plate 103 for arranging the dental object 105 to be heated. The base plate 103 comprises the slit-shaped inlet opening 107 and the slit-shaped outlet opening 111. The slit-shaped inlet opening 107 and the slit-shaped outlet opening 111 are arranged radially to the center 113 of the base plate 103. The slit-shaped inlet opening 107 and the slit-shaped outlet opening 111 are opposite each other with respect to the center 113 of the base plate 103.

Several slit-shaped inlet openings 107 and outlet openings 111 may also be provided, which are arranged radially to the center 113 of the base plate 103 and which are each distributed around the center 113. In general, the inlet openings 107 and outlet openings 111 may also have other geometries.

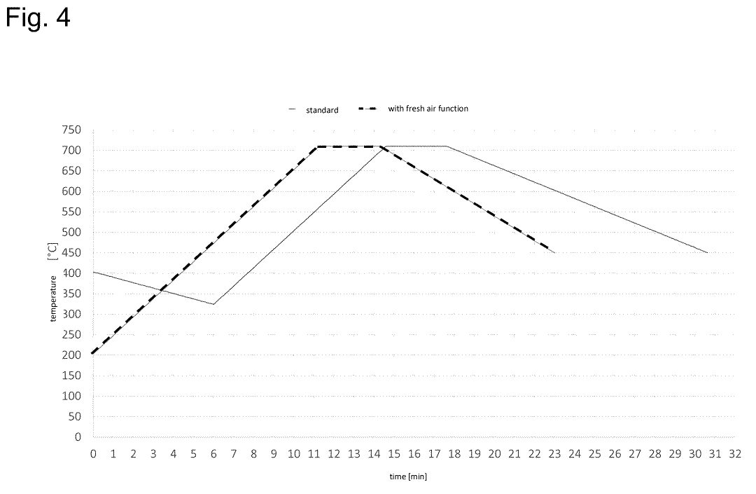

FIG. 4 shows an exemplary course of a firing program. In a typical firing program (solid line), the program is started. The furnace head 115 is open and the dental object 105 is dried with the residual heat of the dental furnace 100 for 6 minutes. The dental furnace 100 is preheated to a standby temperature of 400° C. as standard. During these 6 minutes, the furnace head 115 closes slowly. The moisture and the amount of organic binder of the dental object 100 can escape into the ambient air during these 6 minutes.

The dental furnace 100 cools down during this time. The furnace head 115 is then closed and the heating phase starts, during which the furnace is heated to a holding temperature of 710° C. During this phase, i.e. between 450 and 709° C., a vacuum is generated in the firing chamber 109. At the holding temperature of 710° C., the glaze is fired in a period of 3 minutes. After the holding phase at the holding temperature, the heating of the dental furnace 100 is switched off. The dental object 105 cools down slowly together with the closed dental furnace 100. In the case of non-critical firings, the furnace head 115 can already be opened at this time. Cooling depends on the heat losses of the dental furnace 100. As soon as the dental furnace 100 has cooled down to 450° C., the furnace head 115 is opened and the program is ended. This program lasts approx. 30 minutes.

In a comparable firing program with fresh air function (dashed line), the program is also started. The standby temperature of the dental furnace 100 is reduced, for example to 200° C. This allows the furnace head 115 to be closed immediately at the start of the program without the dental object heating up too quickly. Heating up too quickly can destroy the dental object 105 or impair the quality of the firing. The heating phase to the holding temperature of 710° C. can start immediately.

During the heating phase, the dental object 105 is dried and debinded by the rising temperature and the fresh air function. Fresh air is constantly drawn through the firing chamber 109. The gases and vapors produced during drying and debinding are removed by the vacuum pump 117. From 450° C. and up to 709° C., a vacuum is generated in the firing chamber 109 and fresh air is no longer drawn through the firing chamber 109.

After the holding phase at 710° C., the dental object 105 is cooled in the closed dental furnace 100. Because the standby temperature of the dental furnace 100 has been reduced from 400° C. to 200° C., less energy is stored in the thermal insulation. This means that cooling takes place faster than with the standard program. In addition, the fresh air function is switched on again during this cooling process. The fresh and cold air flowing through the firing chamber 109 heats up and helps to remove thermal energy from the firing chamber 109 in order to further accelerate the cooling of the dental furnace 100 and the dental object 105. The program only takes about 23 minutes.

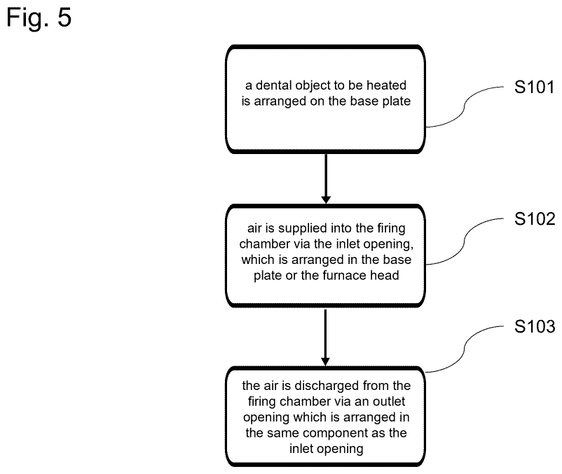

FIG. 5 shows a block diagram of a method of operating a dental furnace 100. In step S101, the dental object 105 to be heated is arranged on the base plate 103. In step S102, air is supplied into the firing chamber 109 via the inlet opening 107, which is arranged in the base plate 103 or the furnace head 115. The air can flow in through the inlet opening 107 when the furnace head 115 is closed and the vacuum pump 117 has been activated. In step S103, the air is discharged from the firing chamber 109 via an outlet opening 111 which is arranged in the same component as the inlet opening 107. Steps S102 and S103 can be carried out simultaneously.

The air can be discharged through the outlet opening 111 when the furnace head 115 is open or closed. This allows convection to be generated around the dental object, which is arranged in the center 113 of the firing chamber 109.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE SIGNS

100 Dental furnace

103 Base plate

105 Dental object

107 Inlet opening

109 Firing chamber

111 Outlet opening

113 Center

115 Furnace head

117 Vacuum pump

119 Filter

121 Inlet valve

123 Outlet valve

1. A dental furnace, comprising:
a base plate for arranging a dental object to be heated;
an inlet opening for supplying air into the firing chamber and an outlet opening for discharging air from the firing chamber, both of which are arranged in the base plate or a furnace head.

2. The dental furnace according to claim 1,
wherein the inlet opening and/or the outlet opening is slit-shaped.

3. The dental furnace according to claim 2,
wherein the slit-shaped inlet opening and/or the slit-shaped outlet opening has a length between 35 mm and 45 mm and a width between 0.5 mm and 2 mm.

4. The dental furnace according to claim 2,
wherein the slit-shaped inlet opening and/or the slit-shaped outlet opening is arranged radially to the center of the base plate.

5. The dental furnace according to claim 4,
wherein the slit-shaped inlet opening and the slit-shaped outlet opening are opposite each other with respect to the center of the base plate.

6. The dental furnace according to claim 1,
wherein the inlet opening and/or the outlet opening are configured to guide an air flow around a central region of the base plate.

7. The dental furnace according to claim 1,
wherein the dental furnace comprises a closed furnace head for lowering onto the base plate or a movable base plate.

8. The dental furnace according to claim 1,
wherein the dental furnace comprises several more inlet openings and/or several more outlet openings in the base plate.

9. The dental furnace according to claim 1,
wherein the dental furnace comprises a vacuum pump for generating an air flow through the inlet opening and/or the outlet opening.

10. The dental furnace according to claim 1,
wherein the dental furnace comprises a filter arranged upstream of an inlet valve, an outlet valve and/or a vacuum pump.

11. A method of operating a dental furnace, comprising the steps of:
arranging a dental object to be heated on a base plate; and
discharging air from the firing chamber via an outlet opening and supplying air into the firing chamber via an inlet opening, both of which are arranged in the base plate or a furnace head.

12. The method according to claim 11,
wherein the air is discharged via the outlet opening when the furnace head is open or closed.

13. The method according to claim 11,
wherein the air is discharged by means of a vacuum pump.

14. The method according to claim 13,
wherein the air is supplied when the furnace head is closed.

15. The method according to claim 11,
wherein the air is filtered upstream of an inlet valve, an outlet valve and/or a vacuum pump through a filter.
